(19) United States
(12) Patent Application Publication
(10) Pub. No.: US 2025/0286797 A1
(43) Pub. Date: Sep. 11, 2025

(54) SERVER AND REMOTE QUALITY MEASUREMENT METHOD

(71) Applicant: NIPPON TELEGRAPH AND TELEPHONE CORPORATION, Tokyo (JP)

(72) Inventors: Hiroshi O, Musashino-shi (JP); Kota ASAKA, Musashino-shi (JP); Tatsuya SHIMADA, Musashino-shi (JP)

(73) Assignee: NIPPON TELEGRAPH AND TELEPHONE CORPORATION, Tokyo (JP)

(21) Appl. No.: 18/858,533

(22) PCT Filed: Apr. 25, 2022
(86) PCT No.: PCT/JP2022/018720

§ 371 Date: Oct. 21, 2024

(51) Int. Cl. H04L 43/08; H04L 43/02

(52) U.S. Cl. CPC H04L 43/08; H04L 43/02

(57) ABSTRACT

A server includes a collection unit configured to collect a response to a signal transmitted to each of a plurality of remote devices to be remotely monitored; and
a comparison and determination unit configured to perform comparison and determination using a plurality of responses obtained from the plurality of remote devices at a timing when the responses have been obtained from all of the plurality of remote devices.

### TECHNICAL FIELD

The present invention relates to a server and a remote quality measurement method.

### BACKGROUND ART

Conventionally, a technique for quality assurance control of a network in real time has been proposed. As methods of collecting quality information of a network, there are methods on a request (trigger) basis and methods on a subscription (cycle) basis. In conventional NW quality information collection, quality information is collected from a plurality of remote devices on a request (trigger) basis or a subscription (cycle) basis, and quality assurance control is performed in real time by comparing the collected quality information.

### CITATION LIST

### Non Patent Literature

Non Patent Literature 1: RFC1157, “A Simple Network Management Protocol (SNMP)”, <URL: https://datatracker.ietf.org/doc/html/rfc1157>

Non Patent Literature 2: ITU-T, G.989.3, “40-Gigabit-capable passive optical networks (NG-PON2): Transmission convergence layer specification”

### SUMMARY OF INVENTION

### Technical Problem

However, the timing of receiving quality information from each remote device is not synchronized with the timing of starting comparison. Therefore, there is a problem that a deviation occurs between the two timings, and thus rapid control cannot be performed and optimum control cannot necessarily be realized.

In view of the above circumstances, an object of the present invention is to provide a technique through which optimal quality assurance control can be performed in a communication network.

### Solution to Problem

An aspect of the present invention is a server including a collection unit configured to collect a response to a signal transmitted to each of a plurality of remote devices to be remotely monitored, and a comparison and determination unit configured to perform comparison and determination using a plurality of responses obtained from the plurality of remote devices at a timing when the responses have been obtained from all of the plurality of remote devices.

An aspect of the present invention is a remote quality measurement method including collecting a response to a signal transmitted to each of a plurality of remote devices to be remotely monitored, and performing comparison and determination using a plurality of responses obtained from the plurality of remote devices at a timing when responses have been obtained from all of the plurality of remote devices.

### Advantageous Effects of Invention

According to the present invention, it is possible to perform optimum quality assurance control in a communication network.

### BRIEF DESCRIPTION OF DRAWINGS

FIG. 1 A diagram illustrating a configuration example of a communication system in a first embodiment.

FIG. 2 A flowchart illustrating a flow of processing of a server in the first embodiment.

FIG. 3 A flowchart illustrating a flow of processing of a server in a second embodiment.

FIG. 4 A flowchart illustrating a flow of processing of the server in the second embodiment.

FIG. 5 A diagram illustrating a configuration example of a communication system in a third embodiment.

FIG. 6 A flowchart illustrating a flow of processing of a server in the third embodiment.

### DESCRIPTION OF EMBODIMENTS

Hereinafter, embodiments of the present invention will be described with reference to drawings.

### First Embodiment

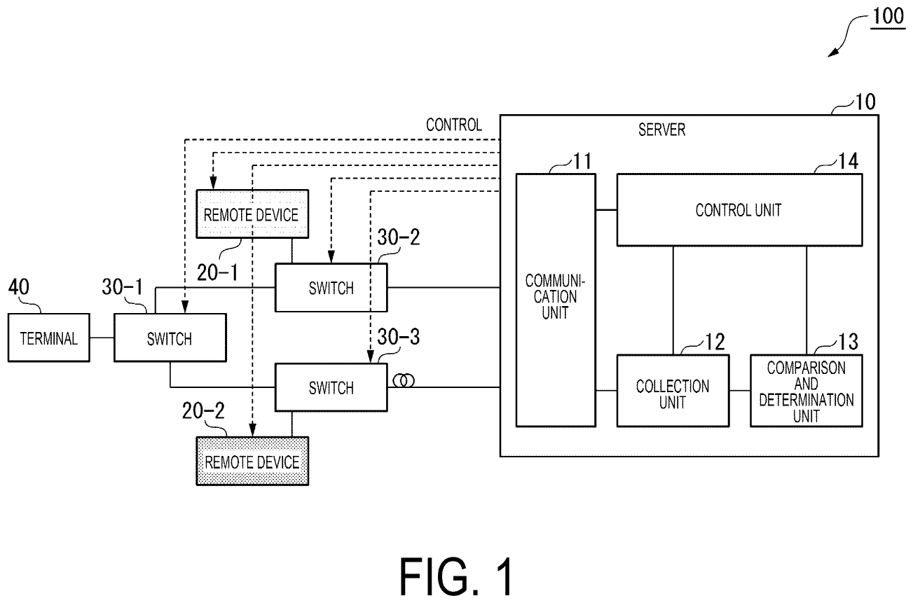

FIG. 1 is a diagram illustrating a configuration example of a communication system 100 in a first embodiment. The communication system 100 includes a server 10, a plurality of remote devices 20-1 and 20-2, a plurality of switches 30-1 to 30-3, and a terminal 40. The number of remote devices 20 and the number of switches 30 are not limited to the numbers illustrated in FIG. 1. Hereinafter, the remote devices 20-1 and 20-2 will be referred to as the remote device 20 in a case in which they are not distinguished, and the switches 30-1 to 30-3 will be referred to as the switch 30 in a case in which they are not distinguished.

In the example illustrated in FIG. 1, the server 10 is connected to the switches 30-2 and 30-3 via a transmission line. The switch 30-2 is connected to the switch 30-1 and the remote device 20-1 via a transmission line. The switch 30-3 is connected to the switch 30-1 and the remote device 20-2 via a transmission line. The switch 30-1 is connected to the switches 30-2 and 30-3 and the terminal 40 via a transmission line. A transmission line may be an optical transmission line such as an optical fiber or an electric line such as a coaxial cable. In the following description, it is assumed that a transmission line is an optical transmission line. Note that the remote devices 20-1 and 20-2 may be connected to the server 10 via the switch 30 through the same line.

The server 10 collects quality information from each of the remote devices 20-1 and 20-2. For example, the server 10 transmits a request or a subscribe signal to the remote devices 20-1 and 20-2. The server 10 receives reports transmitted from the remote devices 20-1 and 20-2. A report is a response to the request or subscribe signal. The server 10 performs comparison and determination using the collected quality information and controls a path and the remote devices 20-1 and 20-2 on the basis of the determination result. The server 10 is an aspect of a monitoring device.

The remote device 20 is a device to be monitored in a network. Upon receiving the request or subscribe signal transmitted from the server 10, the remote device 20 transmits a report to the server 10.

The switch 30 switches a route according to control of the server 10. The switch 30 connects the server 10 and the remote device 20 such that they can communicate or connects the server 10 and the terminal 40 such that they can communicate according to route switching. Although the switch 30 will be described as an optical switch below, the switch 30 may be an electrical switch such as an L2SW (L2 switch) or an L3SW (L3 switch), or a router in a case where electrical communication is performed.

The terminal 40 is a communication device for communicating with the server 10.

Next, a specific configuration of the server 10 will be described. The server 10 includes a communication unit 11, a collection unit 12, a comparison and determination unit 13, and a control unit 14. Note that it is assumed in the first embodiment that the comparison and determination unit 13 does not perform processing until there is an instruction from another functional unit (for example, the collection unit 12). That is, in the first embodiment, the comparison and determination unit 13 is a functional unit that does not operate autonomously. Processing performed by the comparison and determination unit 13 is, for example, quality comparison and determination.

The communication unit 11 communicates with the remote device 20 via the switch 30. The communication unit 11 transmits a request or a subscribe signal to the remote device 20 and receives a report from the remote device 20.

The collection unit 12 collects reports transmitted from respective remote devices 20. The collection unit 12 in the first embodiment causes the comparison and determination unit 13 to execute processing in a case in which reports have been received from all the remote devices 20. Specifically, in a case in which the collection unit 12 has received reports from all the remote devices 20, the collection unit 12 outputs a trigger (hereinafter referred to as an “activation signal”) for causing the comparison and determination unit 13 to execute processing to the comparison and determination unit 13, thereby causing the comparison and determination unit 13 to execute processing. Here, it is assumed that all the remote devices 20 are remote devices 20 whose quality information is to be collected in the server 10 and are registered in advance. The collection unit 12 provides a reception flag for each registered remote device 20 and determines that reports have been received from all the remote devices 20 in a case in which all reception flags are TRUE.

The comparison and determination unit 13 performs processing according to the activation signal output from the collection unit 12. Specifically, when the activation signal is obtained from the collection unit 12, the comparison and determination unit 13 acquires the reports transmitted from the respective remote devices 20 from collection unit 12 and performs quality comparison and determination using the acquired reports. Note that processing performed by the comparison and determination unit 13 is the same as conventional processing. The comparison and determination unit 13 performs comparison and determination, and in a case in which it is determined that control is necessary, notifies the control unit 14 of details of control. On the other hand, the comparison and determination unit 13 performs comparison and determination, and in a case in which it is determined that control is not necessary, does nothing.

The control unit 14 generates a request or subscribe signal. The control unit 14 controls the communication unit 11 to transmit the generated request or subscribe signal to the remote device 20. The control unit 14 controls the remote device 20 and the switch 30 in response to details of notification from the comparison and determination unit 13.

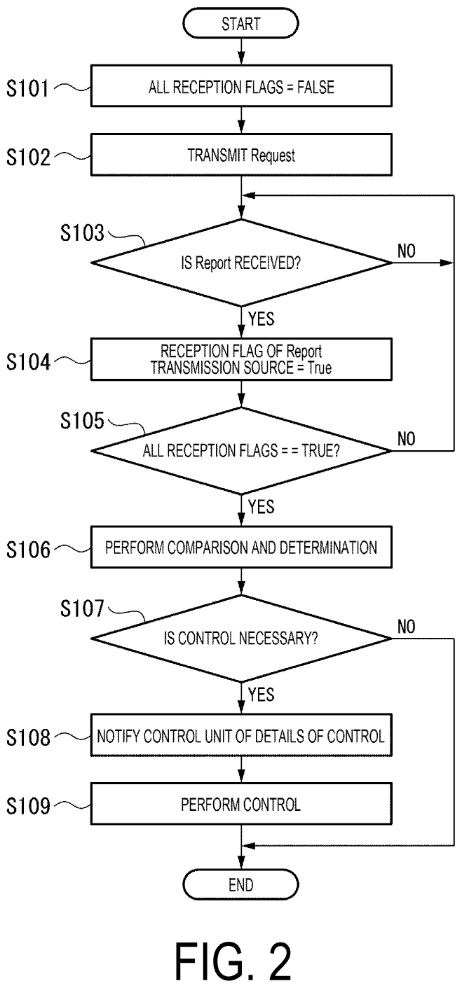

FIG. 2 is a flowchart illustrating a flow of processing of the server 10 in the first embodiment. Note that it is assumed that the server 10 and the remote device 20 are connected via the switch 30 such that they can communicate at the start of processing in FIG. 2.

The collection unit 12 initializes the reception flags corresponding to all the remote devices 20 to FALSE (step S101). The control unit 14 generates a request addressed to each remote device 20. The control unit 14 transmits the request to each remote device 20 via the communication unit 11 (step S102). Note that, although the configuration in which the server 10 transmits a request to each remote device 20 has been described here, the server 10 may transmit a subscribe signal to each remote device 20.

The request transmitted from the server 10 is received by the remote device 20-1 via the switch 30-2. The request transmitted from the server 10 is received by the remote device 20-2 via the switch 30-3. The collection unit 12 determines whether a report has been received (step S103). If it is determined that a report has not been received (NO in step S103), the collection unit 12 waits until a report is received.

On the other hand, if it is determined that a report has been received (YES in step S103), the collection unit 12 changes the reception flag of the remote device 20 that is the transmission source of the report (for example, the remote device 20-1) from FALSE to TRUE (step S104). Thereafter, the collection unit 12 determines whether or not all the reception flags are TRUE (step S105). If it is determined that not all the reception flags are TRUE (some or all of the reception flags are FALSE) (NO in step S105), the collection unit 12 waits until a further report is received.

As an example, in the reception flags of the collection unit 12, only the reception flag corresponding to the remote device 20-1 is TRUE, and only the reception flag corresponding to the remote device 20-2 is FALSE in the above-described example. Therefore, the collection unit 12 determines that not all the reception flags are TRUE.

Thereafter, when a report transmitted from the remote device 20-2 is received in processing of step S103, the collection unit 12 changes the reception flag of the remote device 20 that is the transmission source of the report (for example, the remote device 20-2) from FALSE to TRUE. The collection unit 12 determines whether or not all the reception flags are TRUE. In this case, in the reception flags of the collection unit 12, the reception flag corresponding to the remote device 20-1 and the reception flag corresponding to the remote device 20-2 are TRUE. Therefore, the collection unit 12 determines that all the reception flags are TRUE.

As described above, if it is determined that all the reception flags are TRUE (YES in step S105), the collection unit 12 outputs an activation signal to the comparison and determination unit 13. The collection unit 12 may reset all the reception flags to FALSE after outputting the activation signal.

When the activation signal is obtained from the collection unit 12, the comparison and determination unit 13 acquires the report transmitted from each remote device 20 from the collection unit 12. The comparison determination unit 13 performs comparison determination using the acquired report of each remote device 20 (step S106). As a result of comparison and determination, the comparison and determination unit 13 determines whether or not control is necessary (step S107). If it is determined that control is not necessary (NO in step S107), the comparison and determination unit 13 ends processing.

On the other hand, if it is determined that control is necessary (YES in step S107), the comparison and determination unit 13 notifies the control unit 14 of details of control (step S108). The control unit 14 generates a control signal for controlling the remote device 20 or the switch 30 on the basis of the details of control notified of by the comparison and determination unit 13. The control unit 14 performs control by transmitting the generated control signal to the remote device 20 or the switch 30 via the communication unit 11 (step S109).

According to the communication system 100 configured as described above, the comparison and determination unit 13 is caused to execute comparison and determination processing at the timing when the collection unit 12 has received reports from all remote devices 20. Accordingly, the timing of receiving quality information from each remote device 20 and the timing of starting comparison and determination are aligned. Therefore, optimum quality assurance control in a communication network can be performed.

### Second Embodiment

In the first embodiment, the configuration in which the comparison and determination unit operates according to the activation signal from the collection unit has been described. In a second embodiment, a configuration in which the comparison and determination unit autonomously operates will be described.

A system configuration in the second embodiment is similar to that in the first embodiment. Furthermore, functional units included in the server 10 are similar to those in the first embodiment except that the comparison and determination unit 13 autonomously operates and the activation signal is not output from the collection unit 12. Here, in a case in which the comparison and determination unit 13 autonomously operates, the comparison and determination unit 13 reads the reception flags held by the collection unit 12 at a high speed without synchronizing with processing of the collection unit 12.

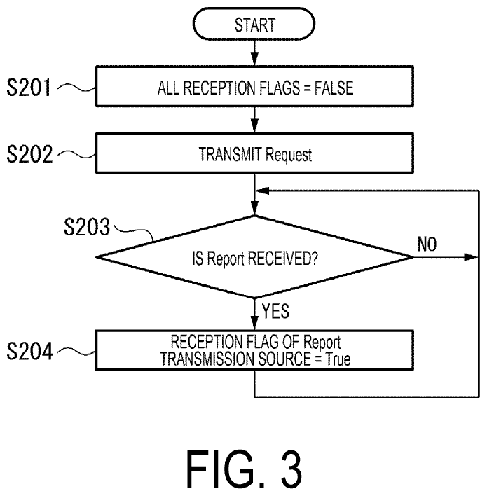

FIG. 3 is a flowchart illustrating a flow of processing of the server 10 in the second embodiment. Note that it is assumed that the server 10 and the remote device 20 are connected via the switch 30 such that they can communicate at the start of processing of FIG. 3. In FIG. 3, processing performed by the collection unit 12 will be mainly described.

The collection unit 12 initializes the reception flags corresponding to all the remote devices 20 to FALSE (step S201). The control unit 14 generates a request addressed to each remote device 20. The control unit 14 transmits the request to each remote device 20 via the communication unit 11 (step S202). Note that, although the configuration in which the server 10 transmits a request to each remote device 20 has been described here, the server 10 may transmit a subscribe signal to each remote device 20.

The request transmitted from the server 10 is received by the remote device 20-1 via the switch 30-2. The request transmitted from the server 10 is received by the remote device 20-2 via the switch 30-3. The collection unit 12 determines whether a report has been received (step S203). If it is determined that a report has not been received (NO in step S203), the collection unit 12 waits until a report is received.

On the other hand, if it is determined that a report has been received (YES in step S203), the collection unit 12 changes the reception flag of the remote device 20 (for example, remote device 20-1) that is the transmission source of the report from FALSE to TRUE (step S204). Thereafter, the collection unit 12 repeatedly executes processing of step S203 and subsequent processing until reports are obtained from all the remote devices 20.

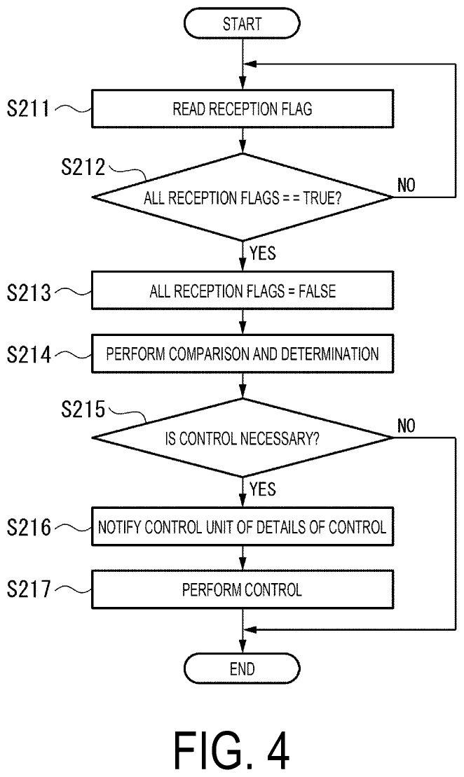

FIG. 4 is a flowchart illustrating a flow of processing of the server 10 in the second embodiment. In FIG. 4, processing performed by the comparison and determination unit 13 will be mainly described.

The comparison and determination unit 13 reads reception flags of the collection unit 12 at a high speed (step S211). The comparison and determination unit 13 determines whether or not all reception flags are TRUE with reference to the read reception flags of the collection unit 12 (step S212). If the comparison and determination unit 13 determines that not all the reception flags are TRUE (NO in step S212), the comparison and determination unit 13 reads the reception flags of the collection unit 12 again at a high speed.

On the other hand, if it is determined that all the reception flags are TRUE (YES in step S212), the comparison and determination unit 13 resets all the reception flags of the collection unit 12 to FALSE (step S213). The comparison and determination unit 13 acquires the report of each remote device 20 from the collection unit 12 and performs comparison determination using the acquired report of each remote device 20 (step S214). As a result of comparison and determination, the comparison and determination unit 13 determines whether or not control is necessary (step S215). If it is determined that control is not necessary (NO in step S215), the comparison and determination unit 13 ends processing.

On the other hand, if it is determined that control is necessary (YES in step S215), the comparison and determination unit 13 notifies the control unit 14 of details of control (step S216). The control unit 14 generates a control signal for controlling the remote device 20 or the switch 30 on the basis of the details of control notified of by the comparison and determination unit 13. The control unit 14 performs control by transmitting the generated control signal to the remote device 20 or the switch 30 via the communication unit 11 (step S217).

According to the communication system 100 of the second embodiment configured as described above, the comparison and determination unit 13 autonomously monitors reception flags of the collection unit 12 at a high speed, and in a case in which the reception flags corresponding to all the remote devices 20 become TRUE (a state indicating that the reports have been received from all the remote devices 20), performs comparison and determination using the reports obtained from all the remote devices 20 from the collection unit 12. Accordingly, the timing of receiving quality information from each remote device 20 and the timing of starting comparison and determination are aligned. Therefore, optimum quality assurance control in a communication network can be performed.

### Third Embodiment

In a third embodiment, a configuration in which the comparison and determination unit is caused to execute processing in accordance with a time at which a report is predicted to be received will be described.

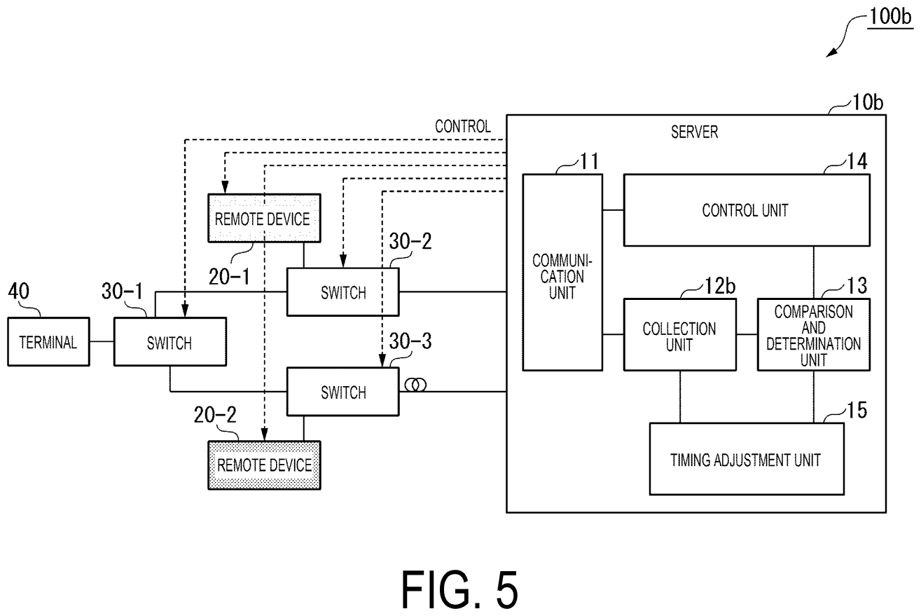

FIG. 5 is a diagram illustrating a configuration example of a communication system 100b in the third embodiment. The communication system 100b includes a server 10b, a plurality of remote devices 20-1 and 20-2, a plurality of switches 30-1 to 30-3, and a terminal 40.

The communication system 100b is different from the communication system 100 in that the server 10b is provided instead of the server 10. Other components of the communication system 100b are similar to those of the communication system 100. Hereinafter, differences from the communication system 100 will be described.

The server 10b includes a communication unit 11, a collection unit 12b, a comparison and determination unit 13, a control unit 14, and a timing adjustment unit 15. Note that, similarly to the first embodiment, it is assumed that the comparison and determination unit 13 does not perform processing until there is an instruction from another functional unit (for example, the timing adjustment unit 15). That is, in the third embodiment, the comparison and determination unit 13 is a functional unit that does not autonomously operate.

The collection unit 12b collects a report transmitted from each remote device 20. In a case in which the collection unit 12b has received the reports from all the remote devices 20, the collection unit 12b acquires a time (hereinafter referred to as “reception completion time”) at which all the reception flags become TRUE. The collection unit 12b notifies the timing adjustment unit 15 of the acquired information on the reception completion time.

The timing adjustment unit 15 estimates a predicted next report reception time on the basis of information on the past reception completion time notified of by the collection unit 12b. In a case in which a report is periodically transmitted, for example, the timing adjustment unit 15 calculates a difference between two past reception completion times and calculates a time obtained by adding a difference from the last report reception time to the difference as a predicted report reception time. The timing adjustment unit 15 causes the comparison and determination unit 13 to execute processing in accordance with the predicted report reception time. Note that, in a case in which it takes time to process the report received by the collection unit 12b, the timing adjustment unit 15 may consider the time to process the report at the predicted report reception time (for example, add the time to process the report to the predicted report reception time).

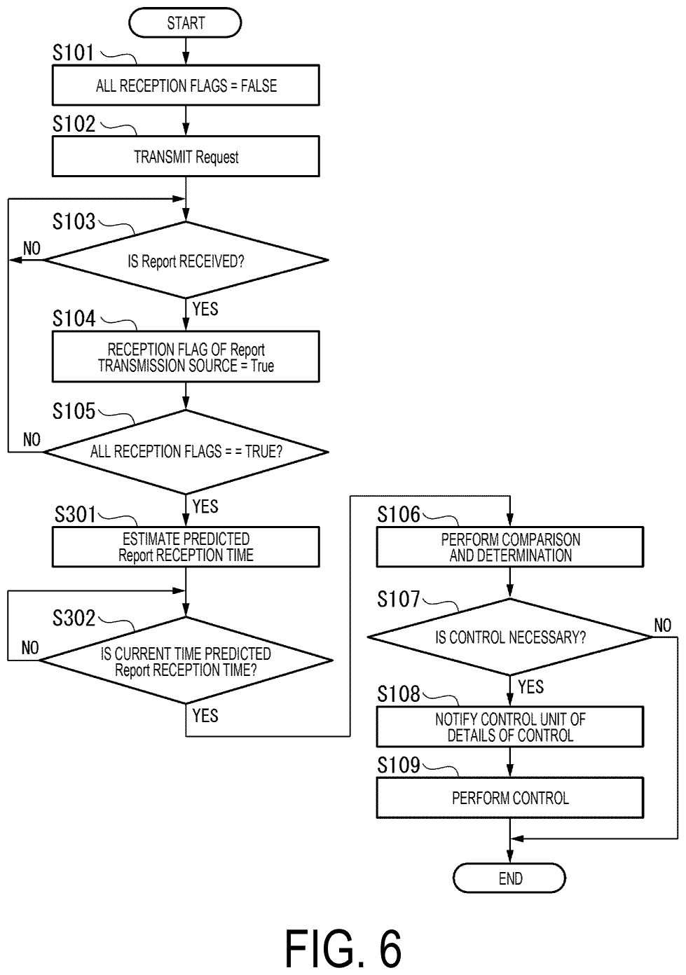

FIG. 6 is a flowchart illustrating a flow of processing of the server 10b in the third embodiment. Note that it is assumed that the server 10b and the remote device 20 are connected via the switch 30 such that they can communicate at the start of processing of FIG. 6. In FIG. 6, processing similar to that in FIG. 2 is denoted by the same reference numeral as that in FIG. 2, and description thereof is omitted.

Processing from step S101 to step S105 is executed, and if it is determined that all the reception flags are TRUE (YES in step S105), the collection unit 12b acquires a reception completion time. The collection unit 12b notifies the timing adjustment unit 15 of the acquired reception completion time.

The timing adjustment unit 15 estimates a predicted next report reception time on the basis of the past reception completion time notified of by the collection unit 12b (step S301). Thereafter, the timing adjustment unit 15 determines whether or not the current time is the predicted report reception time (step S302). If it is determined that the current time is not the predicted report reception time (NO in step S302), the timing adjustment unit 15 waits until the current time reaches the predicted report reception time.

On the other hand, if it is determined that the current time is the predicted report reception time (YES in step S302), the timing adjustment unit 15 causes the comparison and determination unit 13 to execute processing (step S303). Specifically, the timing adjustment unit 15 causes the comparison and determination unit 13 to execute the processing by outputting an activation signal to the comparison and determination unit 13 at the timing when the current time reaches the predicted report reception time. Thereafter, processing of step S106 and subsequent steps are executed.

According to the communication system 100b configured as described above, a predicted next report reception time is estimated on the basis of the time at which reception of reports from all the remote devices 20 is completed (reception completion time). Then, the timing adjustment unit 15 causes the comparison and determination unit 13 to execute comparison and determination processing in accordance with the predicted report reception time. The comparison and determination unit 13 performs comparison and determination at a timing when a report is received. Accordingly, the timing of receiving quality information from each remote device 20 and the timing of starting comparison and determination are aligned. Therefore, optimum quality assurance control in a communication network can be performed.

Some functional units of the servers 10 and 10b and the remote device 20 in the above-described embodiments may be realized by a computer. In that case, a program for realizing these functions may be recorded in a computer-readable recording medium, and the functions may be realized by causing a computer to read and execute the program recorded in this recording medium. Note that the “computer system” mentioned herein includes an OS and hardware such as peripheral devices.

In addition, the “computer-readable recording medium” refers to a portable medium such as a flexible disk, a magneto-optical disc, a ROM, or a CD-ROM or a storage device such as a hard disk included in the computer system. Further, the “computer-readable recording medium” may include a medium that dynamically holds the program for a short time, such as a communication line in a case where the program is transmitted via a network such as the Internet or a communication channel such as a telephone line, and a medium that holds the program for a certain period of time, such as a volatile memory inside a computer system serving as a server or a client in that case. In addition, the aforementioned program may be for realizing some of the functions described above, may realize the functions described above by a combination with a program already recorded in the computer system, or may be realized using a programmable logic device such as an FPGA.

Although the embodiments of the present invention has been described in detail with reference to the drawings, the specific configuration is not limited to these embodiments and includes design and the like within a range not departing from the gist of the present invention.

### INDUSTRIAL APPLICABILITY

The present invention can be applied to a communication system that collects quality information of a network.

### REFERENCE SIGNS LIST

10, 10b Server
20, 20-1 to 20-2 Remote device
30, 30-1 to 30-3 Switch
40 Terminal
11 Communication unit
12, 12b Collection unit
13 Comparison and determination unit
14 Control unit
15 Timing adjustment unit

1. A server comprising:
a collector configured to collect a response to a signal transmitted to each of a plurality of remote devices to be remotely monitored; and
a comparison and determiner configured to perform comparison and determination using a plurality of responses obtained from the plurality of remote devices at a timing when the responses have been obtained from all of the plurality of remote devices.

2. The server according to claim 1, wherein the collector holds a flag indicating whether or not a response has been obtained for each remote device, each time a response is obtained from each remote device, changes a state of the flag corresponding to a remote device from which a response has been obtained to a state indicating that the response has been obtained, and outputs an activation signal for causing the comparison and
determiner to execute processing to the comparison and
determiner at a timing when the state of the flag has become a state indicating that responses have been obtained from all of the plurality of remote devices, and
the comparison and determiner performs comparison and determination using a plurality of responses obtained from all of the plurality of remote devices when the activation signal is acquired.

3. The server according to claim 1, wherein the collector holds a flag indicating whether or not a response has been obtained for each remote device, each time a response is obtained from each remote device, changes a state of the flag corresponding to a remote device from which a response has been obtained to a state indicating that the response has been obtained, and
the comparison and determiner monitors a flag in the collector and performs comparison and determination using a plurality of responses obtained from all of the plurality of remote devices at a timing when a state of the flag has become a state indicating that responses have been obtained from all of the plurality of remote devices.

4. The server according to claim 1, further comprising a timing adjuster configured to predict a time at which responses are received from the remote devices,
wherein the collector holds a flag indicating whether or not a response has been obtained for each remote device, each time a response is obtained from each remote device, changes a state of the flag corresponding to a remote device from which a response has been obtained to a state indicating that the response has been obtained, and notifies the timing adjuster of a time when the state of the flag has become a state indicating that responses have been obtained from all of the plurality of remote devices as a reception completion time,
the timing adjuster calculates a predicted reception time that is a time at which a response is received next from the remote device on the basis of information on the reception completion time, and outputs an activation signal for causing the comparison and determiner to execute processing to the comparison and determiner at the calculated predicted reception time, and
the comparison and determiner performs comparison and determination using a plurality of responses obtained from all of the plurality of remote devices when the activation signal is acquired.

5. The server according to claim 4, wherein, in a case in which a time is required for processing of a response in the collector, the timing adjuster adds the time required for processing of a response to the predicted reception time and outputs the activation signal to the comparison and determiner.

6. A remote quality measurement method comprising:
collecting a response to a signal transmitted to each of a plurality of remote devices to be remotely monitored; and
performing comparison and determination using a plurality of responses obtained from the plurality of remote devices at a timing when responses have been obtained from all of the plurality of remote devices.
